(19) United States
(12) Patent Application Publication
(10) Pub. No.: US 2024/0085324 A1
(43) Pub. Date: Mar. 14, 2024

(54) METHOD AND APPARATUS FOR MAIN DETECTOR SYNCHRONIZATION OF OPTICALLY BASED SECOND HARMONIC GENERATION MEASUREMENTS

(71) Applicant: FemtoMetrix, Inc., Los Angeles, CA (US)

(72) Inventors: Anatoly A. Shtykov, Irvine, CA (US); Michael Brandon Orozco, Santa Ana, CA (US)

(21) Appl. No.: 18/462,073

(22) Filed: Sep. 6, 2023

Related U.S. Application Data
(60) Provisional application No. 63/404,880, filed on Sep. 8, 2022.

(51) Int. Cl. G01N 21/63

(52) U.S. Cl. CPC G01N 21/636; G01N 2021/637; G01N 2201/067

(57) ABSTRACT

Methods are disclosed for improving one or more of jitter/timing, signal-to-noise ratio, signal integrity, stability, and repeatability of generation and measurement of Second Harmonic Generation (SHG) signals generated by a sample upon illumination by a light beam. The method may use precision hardware to control the generation of SHG signal and synchronize it with the optical detection process to improve the reliability and accuracy of measured SHG signals. A precise measurement of the initial SHG signal (Iₒ) involves accurate temporal alignment between optical excitation and detection of the resulting SHG signal. Various disclosed systems and methods use high-speed Pockels Cell (PC) for controlling incident light, and precision electronics for synchronization.

### PRIORITY CLAIM

This application claims the priority benefit of U.S. Patent Prov. App. 63/404,880, entitled METHOD AND APPARATUS FOR MAIN DETECTOR SYNCHRONIZATION OF OPTICALLY BASED SECOND HARMONIC GENERATION MEASUREMENTS, filed Sep. 8, 2022, which is incorporated herein by reference in its entirety.

### BACKGROUND

### Field

Various systems and methods described herein are in the technical field of semiconductor wafer testing, and more particularly, in the technical field of non-contact and non-invasive methods of characterizing such wafers using light.

### Description of the Related Art

The determination of electrical properties of (i) a dielectric disposed on a semiconductor wafer, (ii) the interface between the dielectric and semiconductor, and/or (iii) the lifetime of a charge carrier of the semiconductor wafer can be used during production of such wafers and/or fabrication of devices on such wafers to monitor and maintain their quality. Methods of determine the such electrical properties can thus be beneficial.

### SUMMARY

Second harmonic generation measurement in optical domain can be used to measure and characterize properties of dielectrics, semiconductors, and the corresponding interfaces based, for example, on Electric Field Induced Second Harmonic (EFISH) light generation. These measurements may be referred to herein as EFISH measurements. Various methods and apparatus disclosed herein may employ an optical detector (e.g., a photodetector) and a pulse counter that is controlled separately, to allow for detection of SHG signals used to make EFISH measurements. Additionally, in some examples, an amplifier may be used to amplify a signal generated by the detector before it is fed to the pulse counter.

In some cases, to implement precision control of the time during which a sample is illuminated, a Pockels cell (or another electro-optical switch) is added to the optical path between the light source (e.g., a laser) that illuminates the sample and the sample to block or allow transmission of light generated by the light source that is directed toward the sample. In some examples, a mechanical shutter may be added between the Pockels cell and the sample along the same optical path and in series with the Pockels cell. The mechanical shutter may remain open during SHG measurement or during a time that the Pockels cell blocks the light emitted by the light source. In some examples, the mechanical shutter may allow the Pockels cell to stay in transmissive state without illuminating the sample, possibly avoiding application of high voltage to the Pockels cell during those times.

Using a mechanical shutter alone for switching light may cause non-deterministic timing variations due to the nature of mechanical movement parts/blade inside the shutter and contribute to non-deterministic error in SHG measurements, especially for measuring the initial SHG (Iₒ) value. Since the mechanical shutter is relatively slow, if the Pockels cell is not used, when the shutter is opened light gradually increases during a relatively long opening period. As such the intensity of incident light on the sample increases slower than a desired rate, potentially resulting in smearing of the measured Iₒ value. On the other hand, using a Pockels cell alone may require a high voltage continuously applied on the cell during the time that the incident light should be switched off possibly leading to long-term fluctuations and degradation of the performance of the system. The proposed approach allows for having a very precise timing provided by the Pockels cell, without the need for continuous application of high voltage on the Pockels cell, thereby reducing or eliminating long term drift and degradation of the system. In other words, the high voltage may be applied on the Pockels cell for a very short periods of time, e.g., when the mechanical shutter is opened prior to a SHG generation period.

In some implementations, a novel triggering method may be used to control the Pockels cell (or other types of optical switches), mechanical shutter, and/or the pulse counter to synchronize the optical excitation (illumination of the sample) and the detection of the resulting SHG signal.

The optical switch (e.g., Pockels cell) combined with the mechanical shutter and the disclosed triggering methods may improve the flexibility of the detector configuration (e.g., by providing additional degrees of freedom), allowing for enhanced or optimized performance of the system through a precision integration trigger, improved gating and a detector that can be configured to provide the desired sensitivity levels.

Precision control of system synchronization that comprises triggering the Pockels cell, the mechanical shutter and the pulse counter may be performed by a trigger control loop that utilizes hardware generated trigger signals and therefore eliminating timing delays associated with computer processors, memory access, software, and/or detector controller firmware delays.

Furthermore, triggering signals for all components (e.g., the optical switch, the mechanical shutter, and the pulse counter) may be generated by a single device in the system (e.g., by a precision signal generator) eliminating the delays associated with usages of multiple sources of trigger signals. For example, a specially configured multi-channel precision signal generator may control the optical switch, the mechanical shutter, and the pulse counter.

System performance may be partially improved by using a pulse counter triggered by the precision signal generator, to control measurement time windows for the detected SHG signals generated by the detector. Such systems may provide precise synchronization of the generation and detection. Such a method, for example, is expected to provide more precise control compared to an approach using software running on a computer, referred to as the protocol command trigger. Higher resolution of the detector gate time may provide more precise timing of the SHG measurement process and better pulse-pair timing resolution (resolving two pulses that are coming close to each other) resulting in improve signal integrity.

### BRIEF DESCRIPTION OF THE DRAWING

FIG. 1 is a diagram showing an example system for synchronizing excitation and detection of SHG signals.

FIG. 2 schematically shows example “state” diagrams for a cycle of synchronized SHG measurement process performed by the system shown in FIG. 1.

FIGS. 3A and 3B are flow diagrams representing example processes for synchronized SHG measurement using the system shown in FIG. 1.

FIG. 4 illustrates example synchronization signals used for controlling the mechanical shutter, the Pockels cell, and the detection window.

FIG. 5 illustrates example synchronization signals provided to the high voltage generator and the voltage applied on the Pockels cell.

### DETAILED DESCRIPTION OF THE INVENTION

Second harmonic generation (SHG) measurement can be used to measure and characterize properties of dielectrics and semiconductors. For example, Electric Field Induced Second Harmonic generation (EFISH) light generated at interfaces between different materials (e.g., dielectrics and semiconductors) can be used to determine the electronic properties of these interfaces using non-contact optical measurements.

In some cases, where study of the dynamic behavior of SHG signals generated by a sample are desired (e.g., for determining recombination lifetime in a region of a sample), the temporal behavior of the signals may be measured with respect to an optical excitation time (e.g., a time at which a light beam becomes incident on the sample). In particular, measuring the intensity and/or intensity variation of the initial SHG (Iₒ) generated substantially at the same time the beam of light (pump beam) incident on the sample, may be desirable for measuring certain parameters of the sample.

However, some EFISH measurement techniques can include significant temporal misalignment (e.g., between the optical excitation and SHG signal detection), which can lead to unacceptable level of SHG detection, jitter/timing, signal-to-noise ratio, signal integrity, stability, and repeatability issues.

Various systems, designs, and methods disclosed herein can reduce, avoid or overcome the above-mentioned problems and others by performing SHG measurements under precise temporal alignment between optical excitation and detection of the resulting SHG signals.

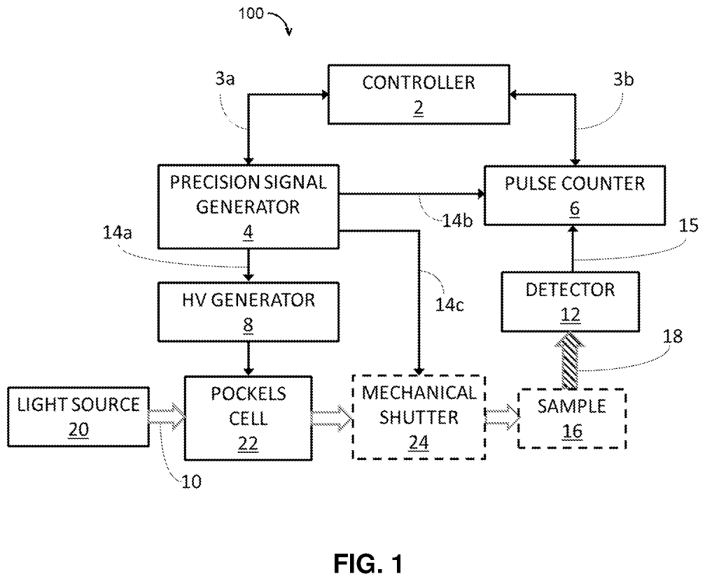

FIG. 1 is a bock diagram showing an example system 100 for synchronizing excitation and detection of SHG signals. In some implementations, the system 100 may include a controller 2, a precision signal generator 4, an in-line mechanical shutter 24, a high voltage (HV) generator 8, a Pockels cell 22, and a pulse counter 6. The controller 2 may be in communication with and configured to control the operation of the precision signal generator 4 and the pulse counter 6 such as in the example shown. For example, the controller 2 may initiate one or more measurement cycles by sending control signals to the precision signal generator 4 and the pulse counter 6. In some cases, the control signal may comprise values or one or more parameters associated with the operation of the precision signal generator 4 and/or the pulse counter 6. In some cases, the controller 2 may receive values of one or more parameters from the precision signal generator 4 and the pulse counter 6.

In some examples, the controller 2 may receive data from the pulse counter 6. The data may comprise measured data generated by the pulse counter (e.g., number of pulses counted during a measurement period). In some cases, the controller 2 may control the configurations of the precision signal generator 4 and/or the pulse counter 6 (e.g., configure them according to configuration stored in the memory of the controller 2 or provided by a user via a user interface). In some cases, the controller 2 may comprise a computing system (e.g., a memory and an electronic processor executing instruction stored in the memory) having a user interface, a microcontroller, a field programmable gate array (FPGA), or the like. The controller 2 may be connected to the precision signal generator 4 and the pulse counter 6 via non-time critical connections (e.g., electrical connections, communication links, and the like). The precision signal generator 4 may be programmed to output a very precise time sequence (e.g., a pulse train) to control timing of: the high voltage (HV) generator 8 (e.g., a time at which the output of the HV generator 8 is enabled or disabled), the pulse counter 6 (e.g., a time at which an input of the pulse counter 6 that received the output from detector 12 is enabled or disabled), and the mechanical shutter 24 (e.g., a time at which the mechanical shutter 24 is opened or closed). The high voltage generator 8 controls the optical transmission through the Pockels cell 22 via direct application of a high voltage signals on the Pockels cell 22 where the timing and amplitude of the high voltage signals are precisely controlled at least partly by the precision signal generator 4. The pulse counter 6 may receive detected signals 15 (electric signals) from a detector 12 indicative of detection of photons (e.g., photons of SH light) by the detector 12.

In some examples, a light source 20 (e.g., a laser source) may generate a light beam 10 directed toward a sample 16 (e.g., to optically measure material properties of the sample 16). The Pockels cell 22 and the mechanical shutter 24 may be positioned inline with the light beam 10 such that the light beam 10 passes through the Pockels cell 22 and then the mechanical shutter 24 before becoming incident on the sample 16. When the Pockels cell 22 is in “OFF” state or high transmission state (e.g., when the HV generator 8 does not apply a high voltage on the Pockels Cell 22) and the mechanical shutter 24 is open, the light beam 10 may become incident on the sample 16 and generate second harmonic (SH) light 18 upon interaction with the sample 16 (e.g., interaction with an interface on the sample 16). The detector 12 may receive the SHG light 18 generated by the sample 16 and produce electric pulses 15 indicative of detection of photons of SH light. The pulse counter 6 may receive the electric signals 15 comprising and electric pulses and count the number of pulses received during a SHG measurement period. In some implementations, the time at which the light beam 10 becomes incident on the sample 16 and the time at which the pulse counter 6 counts the received electric pulses 15 may be precisely controlled by the precision signal generator 4. For example, the precision signal generator 4 may first send a shutter signal 14c to the mechanical shutter 24 to open the shutter, then a generator signal 14a to the HV generator 8 to increase the optical transmission of the Pockels cell 22, and a counter signal 14b to the pulse counter to activate the photon counting process. The precision signal generator 4 may adjust the timing of the shutter signal 14c, generator signal 14a, and the counter signal 14b such that the generation of SHG light by the sample is synchronized with the photon counting process. Such synchronization may improve the signal-to-noise ratio of the optical detection and the photon counting process. In some cases, the shutter signal 14c, generator signal 14a, and the counter signal 14b are delivered by direct electrical connections with low latency. The hardware implemented signal timing implemented by system 100 may improve synchronization from tens of milliseconds to hundreds of microseconds or even down to nanoseconds depending on the high voltage generator used. The controller 2 can configure the precise system timing sequences before the start of the sequence by configuring the pulse generator 4 and this configuration itself is not time-critical and can be performed using a computing system (e.g., a personal computer, a smart phone, a notebook, or a tablet) with a non-real-time operating system. In some cases, one or more critical timings of the events (switching events) during a measurement cycle may be controlled by the hardware or electronics (e.g., the precision signal generator 4). In some cases, a measurement cycle may comprise an initial period, a SHG measurement period, and a final period. In some implementations, the precise timing events, including light control and detection, are controlled via precision hardware control lines used to transmit the shutter signal 14c, generator signal 14a, and the counter signal 14b, from the precision signal generator to the HV generator 4, mechanical shutter 24, and pulse counter 6. This provides a very precise control of the light generation and photon counting process and excellent repeatability of the results that may not be possible using conventional systems, in particular, for measuring the intensity of the initial SHG light (I₀) generated by the sample 16 when light beam 10 illuminates the sample 16.

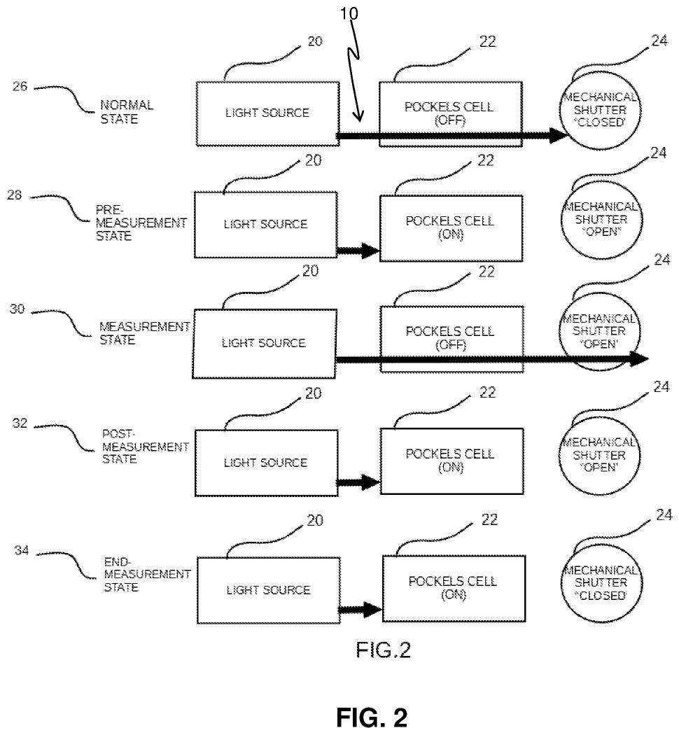

FIG. 2 schematically shows example “state” diagrams representing different states of the Pockels cell 22 and the mechanical shutter 24 between and during measurement cycles associated with the synchronized SHG measurement process performed by the system 100. Each state of the system 100 comprises a combination of states of the Pockels cell 22 and the mechanical shutter 24. As described above the Pockels cell 22 and the mechanical shutter 24 may be aligned with the laser source 20 in series along an optical path to allow the Pockels cell 22 and the mechanical shutter 24 control the transmission of light from the light source 20 to the sample 16.

In some cases, the Pockels cell 22 is configured to pass the light when the high voltage is not applied on the Pockels cell (e.g., when the output of the HV generator 8 is disabled). This state is referred to as the “OFF” state for the Pockels cell 22. When the high voltage is applied (e.g., when the output of the HV generator 8 is enabled), the Pockels cell 22 may block the light. This state is referred to as the “ON” state. Depending on the optical configuration of the system, this logic can be reversed (e.g., the Pockels cell 22, or another type of optical switch may transmit light when in ON state, e.g., when high voltage is applied, and block the light when in OFF state, e.g., when high voltage is not applied). As such in some implementations, the ON/OFF and OPEN/CLOSE sequence of the Pockels cell 22 and the mechanical shutter 24 shown in FIG. 2 can be reversed.

Before the measurement cycle begins the system 100 may be in a normal state 26 where the Pockels cell 22 is in OFF state and the mechanical shutter 24 is closed. The light beam 10 generated by a light source 20 passes through the Pockels cell 22 but is blocked from passing through the mechanical shutter 24. As such, in the normal state 26 the HV generator 8 does not provide any voltage or at least high voltage to the Pockels cell 22 (the state the HV generator in most of the time).

The measurement cycle may begin with an initial period during which the state of the system changes to a pre-measurement state 28 where the Pockels cell 22 in switched to the ON state and the mechanical shutter 24 is opened. In some cases, the precision signal generator 4 may provide a generator signal 14a to the HV generator 8 and cause the HV generator 8 to turn ON the Pockels cell and a shutter signal 14c to the mechanical shutter 24 to open the mechanical shutter 24. In the pre-measurement state 28, the generator signal 14a and the shutter signal 14c may be configured to first turn on the Pockels cell 22, causing the Pockel cell 22 to block most of the light, and then open the mechanical shutter 24. As such the time at which the shutter 24 opens does not affect the sample exposure time. The shutter 24 is already open when the Pockel cell 22 is opened to transmit light.

The measurement cycle may continue with a SHG measurement period during which the state of system changes to a measurement state 30 where the Pockels cell 22 is in the OFF state, thus transmitting light, and the mechanical shutter 24 is open. In the measurement state 30, the light beam 10 passes through the Pockels cell 22 and the mechanical shutter 24, and becomes incident on the sample 16.

The measurement cycle may end with a final period during which the state of the system changes to a post-measurement state 32 and then an end-measurement state 34. In the post-measurement state 32 the Pockels cell 22 is in the ON state and the mechanical shutter 24 is still open. In this state, for example, the light beam 10 is blocked by the Pockels cell 22, preventing it from reaching the sample 16. In the end-measurement state 34, the mechanical shutter 24 is closed while the Pockels cell 22 is in the ON state. Since the mechanical shutter, 24, is closed while the Pockels cell 20 blocks the light beam 16, the exact time at which the mechanical shutter is closed does not affect the sample exposure time.

Next, before the next measurement cycle begins, the Pockels cell 22 is turned off and the system goes back to the normal state 26 where the mechanical shutter 24 blocks the light beam 10 and prevents illumination of the sample 16.

The system 100 and the corresponding states shown in FIG. 2 allow the Pockels cell 22 to stay off in between measurement cycle and thereby mitigates the problems associated with keeping the Pockels cell in ON state in between measurements (e.g., long term drift and degradation of the system)

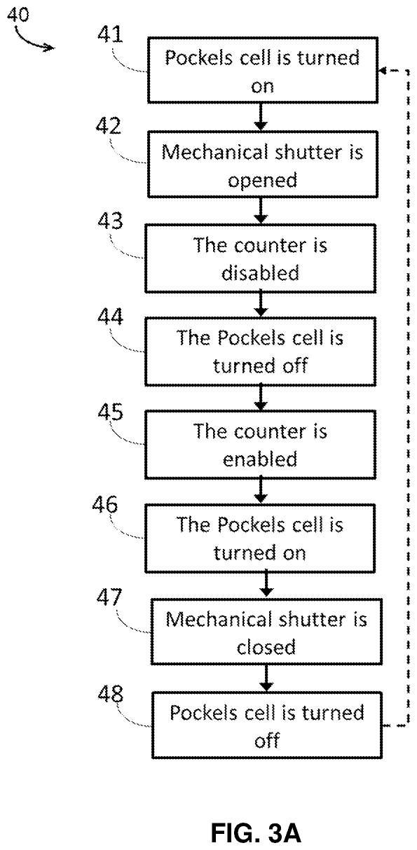

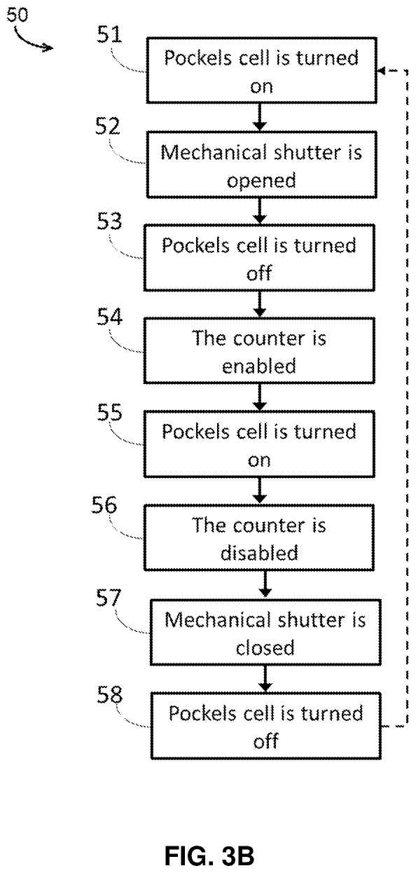

FIGS. 3A and 3B are flow diagrams showing example processes 40 and 50 associated with the measurement cycle described based on the states shown in FIG. 2. In some cases, the precision signal generator 4 may perform the process 40, e.g., by providing generator signal 14a, shutter signal 14c, and counter signal 14b to the HV generator 8, mechanical shutter 24, and pulse counter 6, respectively. The generator signal 14a, shutter signal 14c, and counter signal 14b may comprise pulse trains having repetition rates and pule widths configured to cause the HV generator 8, mechanical shutter 24, and pulse counter 6 to perform the process 40 one or more times. In some cases, the generator signal 14a, shutter signal 14c, and counter signal 14b may be configured by the controller 2 based on data stored in a memory of the controller and/or input provided by a user. In some cases, the controller 2 may control the number of times the measurement cycle is repeated and the time between subsequent measurement cycles.

A measurement cycle according to process 40 may begin with the system in the normal state 26. As described above, in the normal state 26, the light beam 10 is blocked by the mechanical shutter and the Pockels cell is in the “OFF” or transmission state (i.e., the HV generator 8 does not output high voltage). In some cases, the pulse counter may be enabled when the cycle begins. At block 41, the high voltage output of the HV generator 8 is applied on the Pockels cell 22 causing the Pockels cell 22 to be turned on and to block the light beam 10. At block 42, the mechanical shutter 24 is opened. In some cases, the mechanical shutter 24 may open with a first delay with respect to the time at which the Pockels cell 22 is turned on. The uncertainty (e.g., timing jitter, lag due to mechanical nature of shutter, and the like) of the time at which the mechanical shutter 24 becomes fully open, does not affect the sample exposure time because during this period the light beam 10 is blocked by the Pockels cell 22. At block 43 the pulse counter 6 is disabled. At block 44 the Pockels cell is turned off (back to transmission state) allowing the light beam 10 to pass through the already opened mechanical shutter 24 and reach the sample 16. Upon excitation by the light beam 10, the sample 16 generates SH light comprising a stream of SHG photons. At block 45, the pulse counter 6 is enabled and counts the SHG photons received from the sample 16. In some cases, blocks 44 and 45 may be performed simultaneously or substantially simultaneously. For example, pulse counter 6 can be enabled in less than 1 ps, 10 ps, 50 ps, 100 ps after the Pockels cell is turned off. In some cases, block 45 may be performed with a delay after block 44. For example, the pulse counter 6 can be enabled from 1 ns to 10 ns, after the Pockels cell is turned off. In yet other examples, block 45 may be performed before block 44. At block 46, the Pockels cell 22 is turned on to block the light beam 10. At block 47, the mechanical shutter 24 is closed. At block 48, the Pockels cell 22 is turned off. In some cases, the process may go back to block 41, e.g., after a set delay, to initiate and perform another measurement cycle. In some examples, blocks 41, 42, and 43 may be performed during the initial period of the measurement cycle, blocks 44 and 45 may be performed during the SHG measurement period of the measurement cycle, and blocks 46, 47, and 48 may be performed during the final period of the measurement cycle.

A measurement cycle according to the process 50 may begin with the system in the normal state 26 where the light beam 10 is blocked by the mechanical shutter and the Pockels cell is in “OFF” or transmission state (i.e., the HV generator 8 does not output high voltage to the Pockels cell). At block 51, the high voltage output of the HV generator 8 is applied to the Pockels cell 22 causing the Pockels cell 22 to turned on and block light beam 10. At block 52, the mechanical shutter 24 is opened. In some cases, the mechanical shutter 24 may open with a first delay with respect to the time at which the Pockels cell 22 is turned on. The uncertainty (e.g., timing jitter, lag due to mechanical nature of shutter, and the like) of the time at which the mechanical shutter 24 becomes fully open, does not affect the sample exposure time because during this period the light beam 10 is blocked by the Pockels cell 22. At block 53, the Pockels cell is turned off (back to transmission state) allowing the light beam 10 to pass through the already opened mechanical shutter 24 and reach the sample 16. Upon excitation by the light beam 10, the sample 16 generates SHG light comprising a stream of SHG photons. At block 54, the pulse counter 6 is enabled and counts the SHG photons received from the sample 16. In some cases, blocks 53 and 54 may be performed simultaneously or substantially simultaneously. For example, pulse counter 6 can be enabled in less than 1 ps, 10 ps, 50 ps, 100 ps after the Pockels cell is turned off. In some cases, block 54 may be performed with a delay after block 53. For example, the pulse counter 6 can be enabled from 1 ns to 10 ns, after the Pockels cell is turned off. In yet other examples, block 54 may be performed before block 53. At block 55, the Pockels cell 22 is turned on to block the light beam 10 and resume generation of SH light. At block 56, the pulse counter 6 is disabled. In some cases, blocks 55 and 56 may be performed simultaneously or almost simultaneously. For example, pulse counter 6 can be disabled in less than 1 ps, 10 ps, 50 ps, 100 ps after the Pockels 22 cell is turned on. In some cases, blocks 56 may be performed with a delay after block 55. For example, the pulse counter 6 can be disabled from 1 ns to 10 ns, after the Pockels cell 22 is turned off. In yet other examples, block 56 may be performed before block 55. At block 57, the mechanical shutter 24 is closed. At block 58, the Pockels cell 22 is turned off. In some cases, the process may go back to block 51, e.g., after a set delay, to initiate and perform another measurement cycle. In some examples, blocks 51 and 52 may be performed during the initial period of the measurement cycle, blocks 53 and 54 may be performed during the SHG measurement period of the measurement cycle, and blocks 55, 56, 57, and 58 may be performed during the final period of the measurement cycle.

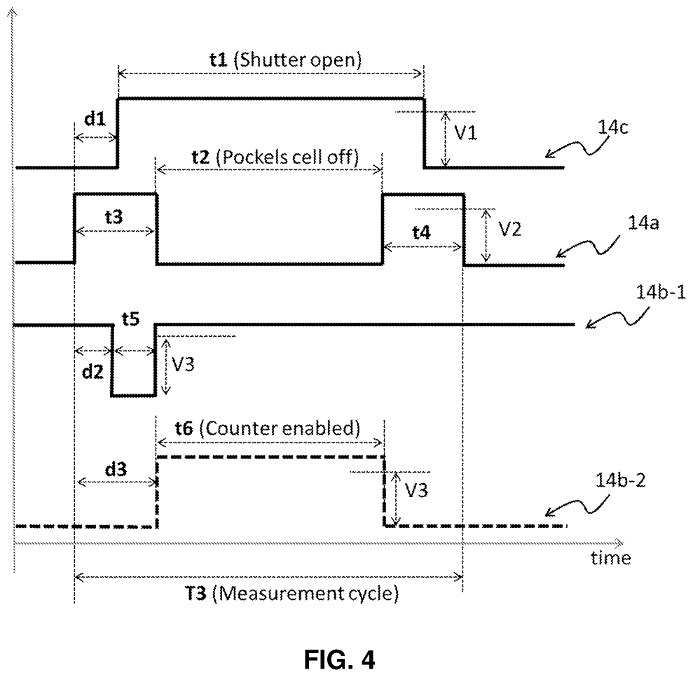

FIG. 4 illustrates examples of temporal variation of the generator signal 14a, the shutter signal 14c, and two examples 14b-1/14b-2 of counter signal 14b used for controlling the mechanical shutter 24, the Pockels cell 22, and the pulse counter 6, respectively, to align and/or synchronize an excitation time window (during which the sample 16 is illuminated) and a measurement time window (during which the output of the detector 12 is measured).

In some implementations, a measurement cycle may have a duration of T3. In some cases, the generator signal 14a, shutter signal 14c, and counter signals 14b-1 or 14b-2 may be configured to control the temporal variation of the states of the Pockels cell 22, mechanical shutter 24, and the pulse counter 6, respectively, during the measurement cycle, according to process 40 or process 50. In some examples, the generator signal 14a, shutter signal 14c, and counter signals 14b-1 or 14b-2 may comprise digital signals configured to control the state of the generator 8, mechanical shutter 24, and the pulse counter 6, respectively, by pulses varying between logic “1” state and logic “0” state, for example. In some implementations, before the beginning of the measurement cycle the generator signal 14a, counter signal 14b-2, and the shutter signal 14c may be in logic zero state. In some implementations, before the beginning of the measurement cycle the counter signal 14b-1 may be in logic “1” state. In some examples, when the shutter signal 14c is in logic “1” state the shutter 24 is open, when the shutter signal 14c is in logic “0” state the shutter is closed, when the generator signal 14a is in logic “1” state the HV generator 8 is ON (the Pockels cell 22 is ON and blocks light), when the generator signal 14a is in logic “0” state the HV generator 8 is OFF (Pockels cell 22 is OFF and transmits light), when the counter signal 14b-1 (or 14b-2) is in logic “1” state the pulse counter 6 is enabled, and when the counter signal 14b-1 (or 14b-2) is in logic “0” state the pulse counter 6 is disabled. In some embodiments, the state of any one of the shutter 24, HV generator 8, and the pulse counter 6 with respect to the logic states of the shutter signal 14c, generator signal 14a, and counter signal 14b-1 (or 14b-2), may be inverted or changed. In various examples, the logic states of any one of the shutter signal 14c, generator signal 14a, and counter signal 14b-1 (or 14b-2), may be configured independently.

The measurement cycle may begin with generator signal 14a changing to a logic “1” where the output of the HV generator 8 is enabled and turns on the Pockels cell 22. The generator signal 14a may stay in logic “1” state for a period t3 during which the Pockels cell 22 is ON and blocks the light beam 10. After the period t3 generator signal 14a may change back to the logic zero state. The generator signal 14a may stay in logic zero state for a period t2 during which the output of the HV generator 8 is disabled and the Pockels cell 22 is in OFF state allowing light to be transmitted. After the period t2, the generator signal 14a may change to a logic “1” again enabling the output of the HV generator 4 and turning on the Pockels cell 22. The generator signal 14a may stay in logic “1” state for a period t4 during which the Pockels cell 22 is ON and blocks the light beam 10. After the period t4 generator signal 14a may change back to the logic zero state and may stay in logic zero until next measurement cycle. In some examples, t3 and t4 can be substantially equal, but need not be. In some cases, the periods t3, t2, and t4 correspond to the initial period, SHG measurement period, and the final period, respectively.

In some cases, with a delay of d1 with respect to the beginning of the measurement cycle (when the generator signal 14a changes to a logic “1”), the shutter signal 14c may change to logic “1” opening the mechanical shutter 24. The shutter signal 14c may stay in logic “1” state for a period t1 during which the mechanical shutter 24 is open and allows any light transmitted through the Pockels cell 22 to become incident on the sample 16. At the end of period t1, the shutter signal 14c may return back to the logic zero state and close the mechanical shutter 24 to block any light transmitted through the Pockels cell 22. The shutter signal 14c may stay in logic zero until next measurement cycle.

In some cases, for example when performing the process 40, the precision signal generator 4 may control the pulse counter 6 using the counter signal 14b-1. In some cases, with a delay of d2 with respect to the beginning of the measurement cycle (when the generator signal 14a changes to a logic “1”), the counter signal 14b-1 may change to logic “0” where the pulse counter 6 is disabled. The counter signal 14b-1 may stay in logic “0” state for a period t5 and then change back to logic state “1” to enable the pulse counter 6. The counter signal 14b-1 may stay in logic ‘1″ state until the next measurement cycle. During a period that the counter signal 14b-1 is in logic “1” state, the generator signal 14a is in logic “0” state, and the shutter signal 14c is in logic “1” state, the counter may receive and count electric pulses generated by the detector 12, e.g., in response to receiving SHG signals from the sample 16.

In some cases, for example when performing the process 50, the precision signal generator 4 may control the pulse counter 6 using the counter signal 14b-2. In some cases, with a delay of d3 with respect to the beginning of the measurement cycle (when the generator signal 14a changes to a logic “1”), the counter signal 14b-2 may change to logic “1” where the pulse counter 6 is enabled. The counter signal 14b-2 may stay in logic “1” state for a period t6 during which the mechanical pule counter 6 receives and counts electric pulses generated by the detector 12, e.g., in response to receiving SHG signals from the sample 16. After the period t6, the counter signal 14b-2 may return back to the logic zero state and disable the pulse counter 6. The counter signal 14b-2 may say in logic zero until next measurement cycle.

In some cases, d1 may be smaller than t3. In some cases, d2 can be smaller than t3. In some cases, d2 can be substantially equal to t3. In some cases, t5 can be equal t3, but may be larger or smaller. In some cases, d2+t5 can be equal or larger than t3 but smaller than t3+t2. In some cases, t1 can be larger than t2. In some cases, t1 can be substantially equal to t2. In other words, the pulse counter 6 is disabled during the time that the Pockels cell 22 is turned on after being ON for t2 seconds (or after t2+t3 seconds after the beginning of the measurement cycle). In some cases, d1+t1 can be smaller than t3+t2+t4 but larger than t3+t2 such that the optical path from the light source 20 to sample 16 is blocked before the Pockels cell 22 is turned off (before and after photon counting). In various implementations, a logic “1” state may for a signal (e.g., 14a/14b/14c) may correspond to a voltage larger than a threshold voltage. In some examples, d2+t5 can be substantially equal to t3 while d2 and t5 smaller or substantially equal to t3. In some examples, d2+t5 can be larger or smaller than t3. In some cases, the threshold voltages for the generator signal 14a, counter signal 14b, and shutter signal 14c, can be V1, V2, and V3 respectively. In some cases, V1, V2, and V3 can be substantially equal.

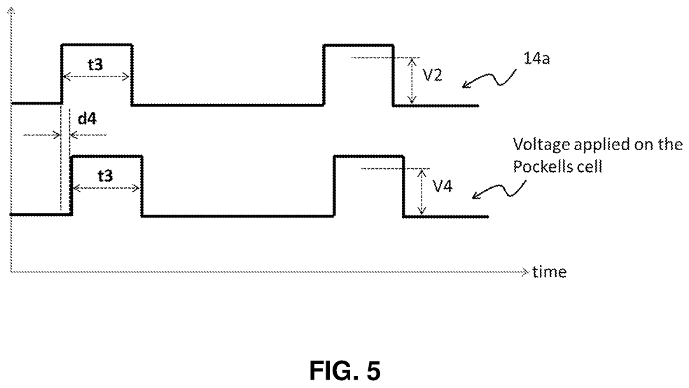

FIG. 5 illustrates the temporal variation of the voltage applied on the Pockels cell 22 during a measurement cycle. In some cases, a temporal variation of voltage applied on the Pockels cell 22 may be similar to that of the generator signal 14a but may be delayed by a delay time d4. The amplitude V4 of the voltage applied on the Pockels cell 22 by the HV generator 5 may depend on the electro-optical characteristics of the Pockels cell 22.

In some cases, the Pockels cell 22 may block the light beam 10 during a mechanical shutter 24 transition from the open to close states and closed to open.

In some cases, the pulse counter 6 may be precisely controlled by the counter signal 14b to allow photon counting to start exactly in alignment with a required delay 66 to the exposure.

In some cases, duration t2 of the exposure of the sample 16 to the light beam 10, may be controlled very precisely by the Pockels cell 22 and may not be affected by the mechanical shutter 24 timing.

The advantages of the present invention may include, without limitation, the SHG system performance improvements of one or more of detection jitter/timing, signal-to-noise ratio, signal integrity, stability, and repeatability.

Further advantages may potentially include having precision light pulse control, timing, and synchronization utilizing Pockels cell to get precision timing and/or having mechanical shutter for blocking the light in a normal state while not having mechanical shutter jitter and delays affecting measurement results.

Further advantages may include counter hardware triggering that provides more precise control compared to the prior art command triggering.

Additionally, higher resolution of the gate time is expected to provide more precise timing of the process, while better pulse-pair resolution of the counter is expected to provide improved signal integrity resolving more valid counts and eliminating two close pulses detected as a single count although these advantages are not guaranteed.

Some embodiments may include a system to precisely control light exposure time and detection system synchronization in the technical field of semiconductor wafer testing, and more particularly, in the technical field of a non-contact, non-invasive method for testing such wafers.

In some implementations, the Pockels Cell 22 may be replaced by other types of optical switches or modulators configured to control transmission of light. In some cases, an optical switch may comprise an electro-optical switch that allows controlling transmission of light using an electric signal. In various designs the optical switch 22 may be faster (e.g., turn on faster and/or turn off faster) than the mechanical shutter 24. In some examples the HV generator 8 may be replaced by an electronic controller configured to provide a voltage or current to the optical switch. In some cases, the optical switch may be directly controllable using the generator signal 14a (e.g., a logic signal). In some examples, the optical switch 22 may include an integrated driver that receives the generator signal 14a and controls the transmissions of the optical switch 22 using the generator signal 14a.

### EXAMPLE EMBODIMENTS

### Group 1

Example 1. A method to improve Second Harmonic Generation (SHG) detection, jitter/timing, signal-to-noise ratio, signal integrity, stability, repeatability or any combination of these, the method comprising: a computer (or controller or microcontroller) setting up a precision signal/pulse generator (PPG) and a detector pulse counter; the PPG simultaneously signaling with precise pulses and delays to an optical shutter, high voltage generator, and to the said counter; said high voltage generator signaling a Pockels cell; the Pockels cell providing an optical switch synchronized with said optical shutter and said counter that is counting detector signal pulses with high synchronization precision.

Example 2. The method as defined in Example 1, whereas the SHG signal detection is performed using a discrete detector or photomultiplier tube (PMT), amplifier, and pulse counter.

Example 3. The method of Example 2 that includes a detector configuration flexibility to allow for increased or optimal sensitivity and performance for the application, precision integration triggering and improved gating time.

Example 4. The method of Example 1, wherein precision control of system synchronization, counter triggering and gating is accomplished through hardware use only, by eliminating a computer, software, and firmware delays from the trigger control loop.

Example 5. The method of Example 4 such that triggering for the PPG, the Pockels cell, the shutter, and the detector is done from a single point.

Example 6. The method as defined in Example 1, where the precision-controlled timing can be adjusted or optimized by providing adjustable module parameters for system configuration and the delays are adjusted optimized for signal detection integrity, stability, and repeatability.

### Group 2

Example 1. A system for measuring second harmonic generation (SHG) light generated by a sample during at least one measurement cycle, the system comprising:
a light source configured to direct light onto said sample to produce SHG light therefrom;
an optical switch configured to transmit a light beam received from said light source when in a first transmissive state, and block the transmission of the light beam when in a second blocking state;
a mechanical shutter configured to transmit the light beam received from the optical switch when said shutter is open and block the light beam received from the optical switch when the shutter is closed;
a pulse counter configured to quantify the SHG light based on an electric signal received from a detector, when said pulse counter is enabled;
a precision signal generator that initiates and terminates the generation and measurement of SHG light during the measurement cycle by controlling the transmission of the light beam from the light source to the sample, wherein the precision signal generator is configured to:
change the state of the optical switch from the second blocking state to the first transmissive state and back to the second blocking state after a time interval, at least twice during the measurement cycle;
open or close the mechanical shutter once during the time interval; and
enable the pulse counter at least during a period when the optical switch is in the first transmissive state.

Example 2. The system of Example 1, wherein the precision signal generator is configured to control the state of the mechanical shutter by providing a shutter signal to the mechanical shutter, the shutter signal comprising electrical pulses.

Example 3. The system of Example 1 or 2, wherein the precision signal generator is configured to control the state of the pulse counter by providing a counter signal to the pulse counter, the counter signal comprising electrical pulses.

Example 4. The system of any of the Examples above, wherein the optical switch comprises an electro-optical switch or modulator.

Example 5. The system of Example 4, further comprising a high voltage (HV) generator, the precision signal generator configured to control the state of the optical switch by providing a generator signal to said high voltage (HV) generator, the generator signal comprising electrical pulses.

Example 6. The system of Example 5, wherein the high voltage (HV) generator changes the state of the optical switch from the first transmissive state to the second blocking state by applying a sufficiently high voltage on the optical switch.

Example 7. The system of any of the Examples above, wherein the optical switch comprises a Pockels cell.

Example 8. The system of any of the Examples above, wherein at the end of the measurement cycle the optical switch is in the first transmissive state, the mechanical shutter is closed, and the pulse counter is disabled.

Example 9. The system of Example 1, wherein the precision signal generator is configured to maintain the optical switch in the first transmissive state during a first time interval and a second time interval after the first time interval, wherein the optical switch in the second blocking state between the first and second time intervals.

Example 10. The system of any of the Examples above, wherein the measurement cycle is extended from the beginning of the first interval to the end of the second time interval.

Example 11. The system of any of the Examples above, wherein the precision signal generator keeps the mechanical shutter open between the first and the second time intervals.

Example 12. The system of any of the Examples above, wherein the SHG light is generated when the optical switch is in first transmissive state and upon interaction of the light beam with the sample.

Example 13. The system of Example 2, wherein the shutter signal further comprises a digital signal.

Example 14. The system of Example 3, wherein the counter signal further comprises a digital signal.

Example 15. The system of any of the Examples above, wherein the precision signal generator controls the state of the optical switch using a digital signal.

Example 16. The system of any of the Examples above, wherein the generator signal comprises a digital signal.

Example 17. The system of any of the Examples above, wherein the detector is a discrete detector or a photomultiplier tube (PMT).

Example 18. The system of any of the Examples above, further comprising a controller configured to control the operation of the precision signal generator.

Example 19. The system of Example 18, wherein the controller comprises at least one electronic processor and non-transitory memory, wherein the controller is configured to control the operation of the precision signal generator by executing machine-readable instructions stored in the memory.

Example 20. The system of Examples 18 or 19, wherein the controller is further configured to control the operation of the pulse counter and receive data from the pulse counter.

Example 21. The system of any of Examples 18-20, wherein the controller is further configured to initiate one or more measurement cycles by a sending control signals to the precision signal generator and/or the pulse counter.

Example 22. The system of any of Examples 18-21, wherein the controller is in electrical communication with said precision signal generator via a first electrical communication line and said precision signal generator is in electrical communication with a high voltage (HV) in electrical communication with said optical switch via a second electrical line, said second electrical line being faster than said first.

Example 23. The system of any of Examples 18-22, wherein the controller is in electrical communication with said precision signal generator via a first electrical communication line and said precision signal generator is in electrical communication with said shutter via a third electrical line, said third electrical line being faster than said first.

Example 24. The system of any of Examples 18-22, wherein the controller is in electrical communication with said precision signal generator via a first electrical communication line and said precision signal generator is in electrical communication with said pulse counter via a fourth electrical line, said fourth electrical line being faster than said first.

Example 25. The system of any of the Examples above, wherein the light source comprises a pulsed laser.

Example 26. The system of any of the Examples above, wherein said optical switch switches on and off faster than said shutter.

Example 27. The system of any of the Examples above, wherein system is inline of a semiconductor fabrication line.

Example 28. A method of measuring second harmonic generation (SHG) light generated by a sample during at least one measurement cycle, the method comprising:
changing a state of an optical switch from a second blocking state to an first transmissive state and back to the second blocking state after a time interval, at least twice during the measurement cycle, wherein the optical switch is configured to transmit a light beam generated by a light source in the first transmissive state and block transmission of the light beam in the second blocking state;
opening or closing a mechanical shutter once during the time interval, wherein the mechanical shutter is configured to transmit the light beam received from the optical switch when the mechanical shutter is open and block the light beam received from the optical switch when mechanical shutter is closed;
enabling a pulse counter at least during a period when the optical switch is in the first transmissive state, wherein the pulse counter is configured to quantify the SHG light based on an electric signal received from a detector, when enabled.

In some implementations, the system 100 can be used inline in a semiconductor fabrication line. For example, an SHG measurement system that is used inline in a semiconductor fabrication line to measure and/or characterize geometrical and/or material properties of samples, may comprise the system 100. In some cases, signals generated by the pulse counter 6 may be used to determine geometrical and/or material properties of the samples.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above-described embodiment, method, and examples, but by all embodiments and methods within the scope and spirit of the invention.

1. A system for measuring second harmonic generation (SHG) light generated by a sample during at least one measurement cycle, the system comprising:
a light source configured to direct light onto said sample to generate SHG light therefrom;
an optical switch configured to transmit a light beam received from said light source when in a first transmissive state, and block the transmission of the light beam when in a second blocking state;
a mechanical shutter configured to transmit the light beam received from the optical switch when the mechanical shutter is open and block the light beam received from the optical switch when the mechanical shutter is closed;
a pulse counter configured to quantify the SHG light based on an electric signal received from a detector, when said pulse counter is enabled;
a precision signal generator that initiates and terminates the generation and measurement of SHG light during the measurement cycle by controlling the transmission of the light beam from the light source to the sample, wherein the precision signal generator is configured to:
change the state of the optical switch from the second blocking state to the first transmissive state and back to the second blocking state after a time interval, at least twice during the measurement cycle;
open or close the mechanical shutter once during the time interval; and
enable the pulse counter at least during a period when the optical switch is in the first transmissive state.

2. (canceled)

3. (canceled)

4. The system of claim 1, wherein the optical switch comprises an electro-optical switch or modulator.

5. The system of claim 4, further comprising a high voltage (HV) generator, the precision signal generator configured to control a state of the optical switch by providing a generator signal to said high voltage (HV) generator, the generator signal comprising electrical pulses.

6. The system of claim 5, wherein the high voltage (HV) generator changes the state of the optical switch from the first transmissive state to the second blocking state by applying a sufficiently high voltage on the optical switch.

7. The system of claim 4, wherein the optical switch comprises a Pockels cell.

8. The system of claim 1, wherein at the end of the measurement cycle, the optical switch is in the first transmissive state, the mechanical shutter is closed, and the pulse counter is disabled.

9. The system of claim 1, wherein the precision signal generator is configured to maintain the optical switch in the first transmissive state during a first time interval and a second time interval after the first time interval, wherein the optical switch in the second blocking state between the first and second time intervals.

10. The system of claim 9, wherein the measurement cycle is extended from the beginning of the first interval to the end of the second time interval.

11. The system of claim 9, wherein the precision signal generator keeps the mechanical shutter open between the first and second time intervals.

12. The system of claim 1, wherein the SHG light is generated when the optical switch is in the first transmissive state and upon interaction of the light beam with the sample.

13. (canceled)

14. (canceled)

15. The system of claim 1, wherein the precision signal generator controls the state of at least one of the optical switch, the mechanical shutter, or the pulse counter using digital signals.

16. (canceled)

17. The system of claim 1, wherein the detector is a discrete detector or a photomultiplier tube (PMT).

18. The system of claim 1, further comprising a controller configured to control the operation of the precision signal generator.

19. The system of claim 18, wherein the controller comprises at least one electronic processor and non-transitory memory, wherein the controller is configured to control the operation of the precision signal generator by executing machine-readable instructions stored in the non-transitory memory.

20. The system of claim 18, wherein the controller is further configured to control the operation of the pulse counter and receive data from the pulse counter.

21. The system of claim 18, wherein the controller is further configured to initiate one or more measurement cycles by sending control signals to the precision signal generator and/or the pulse counter.

22. The system of claim 18, wherein the controller is in electrical communication with said precision signal generator via a first electrical communication line and said precision signal generator is in electrical communication with:
a high voltage (HV) generator, which is in electrical communication with said optical switch via a second electrical line,
said shutter via a third electrical line, and
said pulse counter via a fourth electrical line;
wherein at least one of the second, third, and fourth electrical lines is faster than said first electrical communication line.

23. (canceled)

24. (canceled)

25. (canceled)

26. The system of claim 1, wherein said optical switch switches on and off faster than said shutter.

27. The system of claim 1, wherein system is inline of a semiconductor fabrication line.

28. A method of measuring second harmonic generation (SHG) light generated by a sample during at least one measurement cycle, the method comprising:
changing a state of an optical switch from a second blocking state to a first transmissive state and back to the second blocking state after a time interval, at least twice during the measurement cycle, wherein the optical switch is configured to transmit a light beam generated by a light source in the first transmissive state and block transmission of the light beam in the second blocking state;
opening or closing a mechanical shutter once during the time interval, wherein the mechanical shutter is configured to transmit the light beam received from the optical switch when the mechanical shutter is open and block the light beam received from the optical switch when mechanical shutter is closed;
enabling a pulse counter at least during a period when the optical switch is in the first transmissive state, wherein the pulse counter is configured to quantify the SHG light based on an electric signal received from a detector, when enabled.
